(19) United States
(12) Patent Application Publication
(10) Pub. No.: US 2019/0008163 A1
(43) Pub. Date: Jan. 10, 2019

(54) ANIMAL REPELLANT

(71) Applicant: Bettina Atley, Winfield (CA)

(72) Inventor: Bettina Atley, Winfield (CA)

(21) Appl. No.: 15/642,210

(22) Filed: Jul. 5, 2017

(51) Int. Cl. A01N 65/22; A01N 65/40; A01N 65/38; A01N 65/06; A01N 65/24; A01N 25/02

(52) U.S. Cl. CPC A01N 65/22; A01N 65/40; A01N 25/02; A01N 65/06; A01N 65/24; A01N 65/38

(57) ABSTRACT

A composition comprising a quantity of lavender essential oil, a quantity of garlic essential oil, a quantity of capsicum oleoresin, a quantity of juniper essential oil, a quantity of rosemary essential oil, a quantity of rosemary oleoresin and a quantity of cinnamon essential oil. The composition may include a carrier base such as canola oil, a surfactant such as polysorbate 20 and may be diluted in water. The composition may be applied to a plant to protect the plant from pests.

### BACKGROUND OF THE INVENTION

### 1. Field of Invention

The present invention relates generally to animal repellants and in particular to a food safe composition and method for preparing a composition operable to be applied to plants to prevent them from being eaten by animals.

### 2. Description of Related Art

Pests such as animals and insects are known to cause damage and other nuisances to hold orders and gardeners. Such pests may either damage the plants by eating a quantity of them or may otherwise interfere with a garden by walking through that region also causing damage.

Many methods have been employed to attempt to prevent damage by animals and insects. Some of such methods has been to provide fences or other barriers around the plant or garden to prevent larger animals from entry. Disadvantageous Lee, such barriers are only effective against larger animals that are not able to fit through the barrier or animals that are small enough to not be able to pass over the barrier. Additionally, such barriers may interfere with the appearance or aesthetics of the garden.

Pesticides or chemicals are also frequently employed to discourage some pests from eating the target plants. Disadvantageously however, many such pesticides may be toxic to animals and/or human which limits their desirability. In particular, in the case of vegetables, it is undesirable to apply toxic chemicals to the vegetables which may then be ingested by people. Furthermore, in the case of flowers, it is also undesirable to apply such chemicals to the flowers at a time when they would also be consumed by bees or the like.

### SUMMARY OF THE INVENTION

According to a first embodiment of the present invention there is disclosed a composition comprising a quantity of lavender essential oil, a quantity of garlic essential oil, a quantity of capsicum oleoresin, a quantity of juniper essential oil, a quantity of rosemary essential oil, a quantity of rosemary oleoresin and a quantity of cinnamon essential oil.

The lavender essential oil may be present in an amount between 5 and 30% by weight. The garlic essential oil may be present in an amount between 0.5 and 30% by weight. The capsicum oleoresin may be present in an amount between 2 and 30% by weight. The juniper essential oil may be present in an amount between 0.05 and 30% by weight.

The rosemary essential oil may be present in an amount between 0.01 and 15% by weight. The rosemary oleoresin may be present in an amount between 0.01 and 15% by weight. The cinnamon essential oil may be present in an amount between 0.01 and 15% by weight. The composition may further comprise a carrier base oil. The carrier base oil may comprise canola oil.

The composition may further comprise a surfactant. The surfactant may comprise polysorbate 20. The composition may further comprise a quantity of water. The quantity of water may be present in an amount between 0.5 and 25 grams by weight.

According to a further embodiment of the present invention there is disclosed a method for preparing a composition comprising combining a quantity of lavender essential oil, a quantity of garlic essential oil, a quantity of capsicum oleoresin, a quantity of juniper essential oil, a quantity of rosemary essential oil, a quantity of rosemary oleoresin and a quantity of cinnamon essential oil.

The method may further comprise introducing to the composition a quantity of a base carrier oil. The carrier base oil may comprise canola oil. The method may further comprise introducing to the composition a quantity of a surfactant.

The surfactant may comprise polysorbate 20. The composition may further comprise mixing the composition in a quantity of water.

According to a further embodiment of the present invention there is disclosed a method for protecting a plant from pests comprising providing a composition comprising a quantity of lavender essential oil, a quantity of garlic essential oil, a quantity of capsicum oleoresin, a quantity of juniper essential oil, a quantity of rosemary essential oil, a quantity of rosemary oleoresin and a quantity of cinnamon essential oil and applying the composition to the plant.

The method may further comprise introducing the composition to an applicator. The step of applying may comprise spraying the plant with the composition.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an illustration of a plant being applied with a composition for protecting the plant from pests according to a first embodiment of the present invention.

FIG. 2 is a flow chart depicting a method of preparing the composition for use in protecting plants from pests.

### DETAILED DESCRIPTION

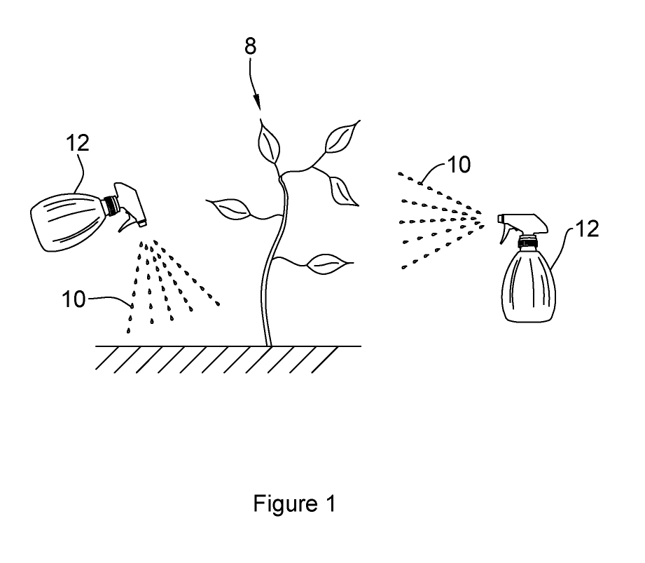

The present invention provides a composition for use in repelling animals, insects and other pests from target plants or regions. According to a first embodiment of the present invention, as illustrated in FIG. 1, a target plant 8 may be protected from being eaten by animals, insects or other pests. As illustrated in FIG. 1, the target plant 8 may be protected by spraying or otherwise applying a repellent composition 10 thereto. As illustrated in FIG. 1, the composition 10 may be applied to the surface of the target plant through the use of a sprayer 12 as are commonly known or through any other known method. Optionally, the composition 10 may be applied to the soil surrounding the target plant to prevent animals, insects and other pests from entering the location of the target plant.

The composition 10 includes a mixture of food grade non-toxic active and inactive ingredients selected to deter or repel a range of pests. By way of non-limiting example, the present composition may include as active ingredients a combination of one or more of lavender essential oil, garlic essential oil, capsicum oleoresin, juniper essential oil, rosemary essential oil, rosemary oleoresin and cinnamon essential oil. It will also be appreciated that the composition may also include a base oil such as by way of non-limiting example, canola oil or the like and may optionally include other additives such as surfactants, preservatives or emulsifiers as will be known in the art to aid in storage or application of the composition to the target plant.

The term “pest” is intended to include living organisms that cause damage to plants, crops or food. Examples of pests include, but are not limited to, animals such as deer, mice, squirrels, reptiles, rodents and other animals (e.g., predators, household pets and wild life) and insects.

As used herein, an “essential oil” is any hydrophobic liquid containing volatile aromatic compounds from plants. They are also known as volatile or ethereal oils, or simply as the “oil of” the plant material from which they were extracted, such as oil of clove. The term “essential” indicates that the oil carries distinctive scent (essence) of the plant. Essential oils are may be extracted or prepared by any known method, but are typically extracted by distillation and hence may be concentrated. Other processes include expression and solvent extraction. Furthermore, as used throughout the specification the term “about” is defined as plus or minus 10% of the stated value.

### Lavender Essential Oil

In some embodiments, the repellent compositions and formulations of the present invention may contain cinnamon essential oil. Cinnamon essential oil (CAS Reg. No. 8000-28-0) is obtained from the Lavandula angustifolia plant by commonly known methods. According to the present invention, cinnamon essential oil may be present in the compositions of the present invention from about 5% by weight to about 30% by weight, although it will be appreciated that other quantities may be utilized as well.

### Garlic Essential Oil

In some embodiments, the repellent compositions and formulations of the present invention may contain garlic essential oil. Garlic essential oil (CAS Reg. No. 8000-78-0) is obtained from the Allium sativum plant by commonly known methods. According to the present invention, garlic essential oil may be present in the compositions of the present invention from about 0.5% by weight to about 30% by weight, although it will be appreciated that other quantities may be utilized as well.

### Capsicum Oleoresin

In some embodiments, the repellent compositions and formulations of the present invention may contain capsium oleoresin. Capsicum oleoresin (CAS Reg. No. 8023-77-6) is obtained from the Capsicum Annum plant by commonly known methods. According to the present invention, capsicum oleoresin may be present in the compositions of the present invention from about 2% by weight to about 30% by weight, although it will be appreciated that other quantities may be utilized as well.

### Juniper Essential Oil

In some embodiments, the repellent compositions and formulations of the present invention may contain juniper essential oil. Juniper essential oil, (CAS Reg. No. 8002-68-4) is obtained from the Juniperus communis plant by commonly known methods. According to the present invention, juniper essential oil may be present in the compositions of the present invention from about 0.5% by weight to about 30% by weight, although it will be appreciated that other quantities may be utilized as well.

### Rosemary Essential Oil

In one embodiment, the compositions and formulations of the present invention may contain rosemary essential oil (CAS Reg. No. 8000-25-7) obtained from the Rosemarinus officinalis plant by commonly known methods. According to the present invention, rosemary essential oil, when present, may be present in the compositions of the present invention from about 0.01% by weight to about 15% by weight, although it will be appreciated that other quantities may be utilized as well.

### Rosemary Oleoresin

In one embodiment, the compositions and formulations of the present invention may contain rosemary essential oil (CAS Reg. No. 3650-09-7) also known as rosemary extract oil is obtained from the Rosemarinus officinalis leaves by commonly known methods. According to the present invention, rosemary oleoresin, when present, may be present in the compositions of the present invention from about 0.01% by weight to about 15% by weight, although it will be appreciated that other quantities may be utilized as well.

### Cinnamon Essential Oil

In one embodiment, the repellent compositions and formulations of the present invention may contain cinnamon essential oil. Cinnamon essential oil (CAS Reg. No. 8015-91-6) obtained from the Cinnamonum cassia plant by commonly known methods. According to the present invention, cinnamon essential oil may be present in the compositions of the present invention from about 0.1% by weight to about 15% by weight, although it will be appreciated that other quantities may be utilized as well.

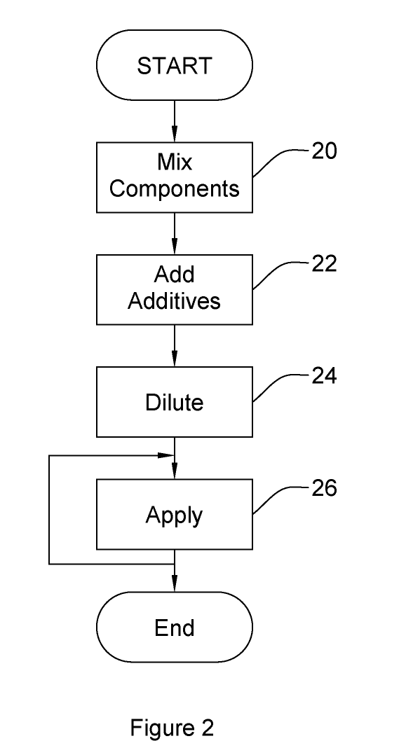

As illustrated in FIG. 2, according to one embodiment of the present invention, the composition 10 may be prepared by mixing pre-measured quantities of the active ingredients together in a container. The active ingredients may be mixed together at room temperature and atmospheric conditions and may optionally be mixed with a carrier base oil, such as, by way of non-limiting example, canola oil in step 20. Optionally, one or more additive or inactive ingredient may be added to the composition to provide one or more enhancement such as preserving the composition, stabilizing the composition or lowering the surface tension to aid application to plants, such as polysorbate 20 or the like in step 22. It will be appreciated that such a composition will form a concentrated form of the composition which may be readily stored or transported. Prior to usage, the concentrated composition may then be diluted into a quantity prior to application to the target plant. By way of non-limiting example, the concentrated composition may be mixed in a quantity of water so as to have a concentration of up to 10% to form the resultant composition 24 for application to the target plant in step 26. It will be appreciated hat the resultant composition may be reapplied to the target plant as frequently as necessary to prolong protection of the plant.

The following example will provide an illustration of the use of the present composition.

### EXAMPLE 1

The composition was prepared in the following percentages by weight:

TABLE 1
Deer Repellent Composition

| | Weight per 1000 mL of |
|---|---|
| Component | Concentrate (grams) |
| Canola oil | 413.1 |
| Lavender essential oil | 209.8 |
| Garlic Essential oil | 139.9 |
| Capsicum oleoresin | 139.9 |
| Juniper essential oil | 69.9 |
| Poloysorbate 20 | 13.9 |
| Rosemary essential oil | 5 |
| Rosemary oleoresin | 5 |
| Cinnamon essential oil | 3.5 |
| | 1.00 kg, total weight |

The above concentrate was then diluted in water at a concentration of about 1% (in particular an amount of about 100 mL was mixed with a quantity of water to form 10 litres of diluted composition).

While specific embodiments of the invention have been described and illustrated, such embodiments should be considered illustrative of the invention only and not as limiting the invention as construed in accordance with the accompanying claims.

What is claimed is:

1. A composition comprising a quantity of lavender essential oil, a quantity of garlic essential oil, a quantity of capsicum oleoresin, a quantity of juniper essential oil, a quantity of rosemary essential oil, a quantity of rosemary oleoresin and a quantity of cinnamon essential oil.

2. The composition of claim 1 wherein said lavender essential oil is present in an amount between 5 and 30% by weight.

3. The composition of claim 1 wherein said garlic essential oil is present in an amount between 0.5 and 30% by weight.

4. The composition of claim 1 wherein said capsicum oleoresin is present in an amount between 2 and 30% by weight.

5. The composition of claim 1 wherein said juniper essential oil is present in an amount between 0.05 and 30% by weight.

6. The composition of claim 1 wherein said rosemary essential oil is present in an amount between 0.01 and 15% by weight.

7. The composition of claim 1 wherein said rosemary oleoresin is present in an amount between 0.01 and 15% by weight.

8. The composition of claim 1 wherein said cinnamon essential oil is present in an amount between 0.01 and 15% by weight.

9. The composition of claim 1 further comprising a carrier base oil.

10. The composition of claim 9 wherein said carrier base oil comprise canola oil.

11. The composition of claim 1 further comprising a surfactant.

12. The composition of claim 11 wherein said surfactant comprises polysorbate 20.

13. The composition of claim 1 further comprising a quantity of water.

14. The composition of claim 13 wherein said quantity of water is present in an amount greater than 90% by volume.

15. A method for preparing a composition comprising combining a quantity of lavender essential oil, a quantity of garlic essential oil, a quantity of capsicum oleoresin, a quantity of juniper essential oil, a quantity of rosemary essential oil, a quantity of rosemary oleoresin and a quantity of cinnamon essential oil.

16. The method of claim 15 further comprising introducing to said composition a quantity of a base carrier oil.

17. The method of claim 16 wherein said carrier base oil comprise canola oil.

18. The method of claim 15 further comprising introducing to said composition a quantity of a surfactant.

19. The method of claim 18 wherein said surfactant comprises polysorbate 20.

20. The composition of claim 1 further comprising mixing said composition in a quantity of water.

21. A method for protecting a plant from pests comprising:
providing a composition comprising a quantity of lavender essential oil, a quantity of garlic essential oil, a quantity of capsicum oleoresin, a quantity of juniper essential oil, a quantity of rosemary essential oil, a quantity of rosemary oleoresin and a quantity of cinnamon essential oil; and
applying said composition to the plant.

22. The method of claim 21 further comprising introducing said composition to an applicator.

23. The method of claim 22 wherein said applying comprises spraying said plant with said composition.
